(19) United States
(12) Patent Application Publication
(10) Pub. No.: US 2019/0342625 A1
(43) Pub. Date: Nov. 7, 2019

(54) Communication System

(71) Applicant: Pop in Technologies Limited, Hamilton (NZ)

(72) Inventor: Robin Jan Fenn, Hamilton (NZ)

(21) Appl. No.: 16/474,481

(22) PCT Filed: Dec. 22, 2017
(86) PCT No.: PCT/NZ2017/050174

§ 371 Date: Jun. 27, 2019

Related U.S. Application Data
(60) Provisional application No. 62/440,314, filed on Dec. 29, 2016.

(51) Int. Cl. H04N 21/61; H04N 21/422; H04N 21/41; H04N 21/4363; H04N 21/475; H04N 21/4788

(52) U.S. Cl. CPC H04N 21/6175; H04N 21/42204; H04N 21/4104; H04N 21/42203; H04N 21/4751; H04N 21/4788; H04N 21/6125; H04N 21/43635

(57) ABSTRACT

A communication system and method of operation for use with a television set and a remote control which acts on the television set to adjust operation of the television set. A control unit is coupled to the television set and to the internet. The control unit receives a signal from the internet and displaying at least a portion of the signal on the television set, wherein the control unit is remotely controlled by the remote control.

### STATEMENT OF CORRESPONDING APPLICATIONS

This application is based the provisional specification filed in relation to U.S. patent application No. 62/440,314, the entire contents of which are incorporated herein by reference.

### TECHNICAL FIELD

The present disclosure relates to a communication system, control unit, and method of operation for communication with a person via a television set.

### BACKGROUND

The population is aging and some find it difficult to keep up with technology advancements or fear new technology. The requirement to have to learn new systems, and having to learn how to work them, is a barrier for many aging persons to adopting new communication options that may currently be available. Many available video communication systems require a level of technical knowledge and skill to both set them up and use them.

With the large number of technical devices available today each having unique controls and function it can be a daunting task for some people to learn how to control them. Furthermore, with many technical devices including their own dedicated remote control to operate the devices, there is increased confusion as to how each of these remote controls function, along with which remote control works with which device.

A further significant problem with an aging population is loneliness and depression due to living alone or being away from close family. Close family are concerned for elderly relatives but it can be costly or difficult to stay in touch with loved ones. Living in different locations or having other personal commitments, such as young family or work, may make it difficult to visit often.

The health industry is required to undertake a large number of home visits to check on patients, which can be very time intensive, with considerable time spent on traveling between different patients. Also some patients may need more assistance or follow-up, especially at times of change, such as with changes in conditions or medication.

Efforts in the past to address this problem have included repurposing existing technology to provide convenient communication in the situations identified above to address the evident need, as well as utilization of new stand alone systems. Special purpose stand alone systems have a large expense, require extensive set up, and fail to take advantage of existing technological equipment which may already be in place. Existing technological solutions tend to require a level of technological sophistication which is beyond the grasp of many elderly individuals and other disabled individuals.

Examples of existing technological solutions that might be utilized to address this need include communications systems that rely upon personal computers (PC) or tablet type devices and web cams that include systems, such as Skype™. Such systems require internet access and considerable system set-up (e.g. creation of an account and an understanding of how the system works to be able to answer or make calls). The quality of these systems may also vary. They also require the PC or tablet device to be on for the call to occur.

Other forms of communication such as text messaging, MSN MESSENGER and phone calls may be very time intensive, especially for health professionals. Not everyone has a mobile phone and even if they do, many elderly people either do not feel comfortable with text communications or may have difficulty in writing or reading text messages on such small phone devices. Also, many such existing technological solutions are only partially effective, either primarily providing text communication, primarily providing voice communication, or only providing video communication on computer, tablet or smart phone screens. Many elderly individuals and other disabled individuals are highly familiar with the operation of a standard television set. For many individuals, this familiarity includes familiarity with a remote control provided with the television set for operation of the television set. Many (if not most) modern television sets include advanced connectivity systems, ports and cables, such as HDMI functionality. These advanced conductivity functionality systems have not been heretofore effectively used to convert a modern television set into a communications tool, and especially to allow the modern television set to function in its typical manner, providing programming without communication, to being converted periodically into a multi media communications tool including Voice and optionally also video and text communication, which can either be primarily or entirely one way or two way, or provide for group communication between more than two individuals.

Some examples of known systems which attempt to address some of the needs identified above are identified as follows. The Speakset UK Company uses SCART connections to turn on a television set. A SCART connector is a physical and electrical interconnection between two pieces of audio-visual equipment, such as a television set and a video cassette recorder (VCR). Each device has a female 21-pin connector interface. A cable with a male plug at each end is used to connect the devices.

Speakset UK provides a product aimed at post-operative care for elderly and NHS use. Systems such as this require a customized remote control, rather than using the existing television set remote control and utilize connectors other than HDMI so that a more complex system results that requires more extensive set up. Furthermore, the individual using the system must be educated on use of a new remote control, rather than being able to use an existing familiar remote control. Another similar prior our system is provided by the Biscoitti company (see U.S. Pat. No. 8,144,182) which also provides a new and dedicated remote control which the user must become familiar with, rather than using an existing familiar TV set remote control. This Biscoitti system requires an internet connection such as WiFi, and requires that someone set up the internet connection.

These existing prior art video communication systems all come with a dedicated remote or control system that requires the user to learn to be able to use the system. Many devices have dedicated remotes and the large number of remote controls can lead to confusion in some users. Even one simple new remote control is often less desirable than programming an existing remote control for the television set to perform a small number of new functions, such as to allow for acceptance of a video “call.”

It is an object of the present invention to address the foregoing problems or at least to provide the public with a useful choice.

Further aspects and advantages of the present invention will become apparent from the ensuing description which is given by way of example only.

### SUMMARY OF THE DISCLOSURE

According to one aspect of the present disclosure there is provided a communication system. The communication system may include a television set, and a remote control which acts on the television set to control the television set. The communication system may include a control unit coupled to the television set and to the internet. The control unit may be configured to receive a signal from the internet and present at least a portion of the signal via the television set. The control unit may be remotely controlled by the remote control.

According to one aspect of the present disclosure there is provided a method for using a television set with an associated remote control configured to control the television set for communication with a user of the television set. The method may include connecting the television set to the internet through a control unit. The method may include receiving a signal sent by a communicator via the internet to the control unit. The method may include controlling, using the control unit, the television set to present at least a portion of the signal via the television set. Presentation of the signal may be controlled, at least in part, by the user operating the remote control to remotely control the control unit.

According to one aspect of the present disclosure there is provided a control unit for a communication system. The control unit may include an internet connection module, for connection to the internet. The control unit may include a television connection module, for connection to a television set. The control unit may include at least one processor. The at least one processor may be configured to receive a communication signal sent from a first communicator via the internet. The at least one processor may be configured to present at least a portion of the communication signal via the television set. The at least one processor may be configured to receive control signals from a remote control of the television set.

According to one aspect of the present disclosure there is provided a communication system. The communication system may include a television set. The communication system may include a control unit coupled to the television set and to the internet. The control unit may be configured to receive a signal from a communicator sent via the internet indicating a communication is to be presented to a user of the television set. The control unit may be configured to determine whether a current state of the television set permits presentation of the communication. The control unit may be configured to control the television set, if required, to achieve a state capable of presenting the communication via the television set.

According to one aspect of the present disclosure there is provided a method for using a television set for communication between a communicator and a user of the television set. The method may include connecting the television set to the internet through a control unit. The method may include receiving a signal sent by the communicator via the internet to the control unit indicating a communication is to be presented to the user of the television set. The method may include determining whether a current state of the television set permits presentation of the communication. The method may include controlling the television set using the control unit to achieve a state capable of presenting the communication via the television set, if required.

According to one aspect of the present disclosure there is provided a control unit for a communication system. The control unit may include an internet connection module, for connection to the internet. The control unit may include a television connection module, for connection to a television set. The control unit may include at least one processor. The at least one processor may be configured to receive a signal from the internet indicating a communication from a communicator is to be presented to a user of the television set. The at least one processor may be configured to determine whether a current state of the television set permits presentation of the communication. The at least one processor may be configured to control the television set to achieve a state capable of presenting the communication via the television set, if required.

According to one aspect of the present disclosure there is provided a control unit for a communication system. The control unit may include an internet connection module, for connection to the internet. The control unit may include a television connection module, for connection to a television set. The control unit may include at least one processor. The at least one processor may be configured to receive a signal from the internet indicating a communication from a communicator is to be presented to a user of the television set. The at least one processor may be configured to determine whether a current state of the television set permits presentation of the communication. The at least one processor may be configured to control the television set to achieve a state capable of presenting the communication via the television set, if required.

Exemplary embodiments of the present disclosure relate to a communication system to enable communication between at least two people or parties or groups. Preferably the at least two people or parties or groups may be in different geographical locations. At least one person may be a receiving person (for example, an elderly person to be monitored or otherwise engaged) that receives communications via a control unit of the communication system and requires minimal set-up or understanding to interact with the communication system. The receiving person may also be enabled to send messages to other users that may communicate with them. A person sending the communications to the receiving person may be a communicator. In some forms, an administrator of the system may set up other users or user groups as communicators for the system or invite new users to use the communication system. The administrator may set-up a private portal for selected members to use for communication. Generally, the administrator may use a web-browser or application program interface (API) on a web-enabled computing device to communicate with the control unit located at the receiving person's location. A new user or communicator may receive an email in a link that allows the user to send messages to the specific control unit. Each user may send messages and share images with the television (TV) connected to the control unit.

The administrator may set up one or more collaboration groups as required, for example a first group including a health professional and one or more family members to discuss health concerns with the receiving person. A second group may include one or more friends or family members. The administrator may also provide administration rights to specific users, access to specific or private folders and/or the ability to send selected types of messages. New users may be added to the system at any time, including during an open communication process.

In one aspect, the communication system requires no or little education for a receiving person to operate. The communication system may provide one or more forms of communication in the form of written messages, video (saved and real-time), documents, alerts, alarms, photographs or other data or media. In some forms, the communication system may be “plug and play” and does not require any new learning for the receiving person to use it. The system may make use of functions existing in well-known devices, such as a primary remote control (e.g. television remote control or satellite TV remote control or DVD device remote control).

The communication system may include a control unit configured to communicate with a television and provide a network interface to provide connectivity—more particularly internet connectivity via an internet service provider (ISP). The control unit may also include a power source. The power source may be a power supply configured to connect to mains power (i.e. standard residential electric power service) or a battery power source, or both. In some forms, the control unit may receive power via a connected device, such as the television. The control unit may further include a unique identification code or key, referred to as an identifier, which is used to allow specific communication with that specific control unit. The identifier may be provided to users to enable them to communicate with the control unit. Each user may also be provided with a unique identifier that enables them to communicate with the specific control unit. The administrator may set up the user unique identifiers as part of the process of inviting other users to use the communication system to contact the receiving person.

In some forms, the control unit may include an internal modem or dongle to enable direct internet connection, for example 3G or 4G dongle or mobile internet device. The control unit may include a WiFi connection adaptor to enable connection to a wireless internet network or a form of local area network (LAN) connection including a wired internet connector such as an Ethernet connector or RJ-45 connector. In some forms, the control unit may include one or more of an internal internet capability, WiFi connectivity, or wired internet connectivity capability.

In some forms, the control unit may be configured to enable direct internet connectivity upon initial set-up and subsequently detect the presence or availability of a local area network (LAN), and more particularly a wireless local area network (WLAN). The control unit may be configured to automatically connect to the available WLAN when possible and then optionally turn off the direct internet connectivity. This automatic WLAN connection preferably does not require any involvement from the receiving person to enable the connection of the control unit to the WLAN. In some circumstances, the control unit may automatically detect a WLAN and advise the administrator of the availability of a WLAN to facilitate the administrator enabling access to the WLAN for communications. For example, to provide a password to enable connection to an available wireless network. In some forms, if the WLAN fails then the direct internet connectivity capability may be activated, preferably automatically, to provide communication access.

In some forms, the control unit may also include an audio capture device or a video capture device or both. The control unit may also be configured to use one or more of the audio input, audio output; video input and video output systems of a television coupled thereto. The control unit may further include one or more of an infrared (IR) sensor, IR receiver or IR transmitter to enable communication to and from a remote control device and/or the television. The control unit may include one or more of a camera, microphone, lights, LED or small display screen.

In some forms, the control unit may communicate with a television using a wired connection such as using a high-definition multimedia interface (HDMI) connection via a cable. When using an HDMI connection to the television the consumer electronics control (CEC) protocol or function may be enabled to allow the remote control in communication with the television (the primary remote) to be used to control the control unit of the communication system.

Other wired connections may include component cables. In other forms, the control unit may communicate with a television via a universal serial bus (USB) connection or device and use a smart application on the television for a web Real-Time communication (WebRTC). In exemplary embodiments, infrared (IR) may be used for communication between the control unit and the television, for example using IR remote control protocols. Other interconnection systems already in existence or developed in the future could alternatively be utilized.

Infrared (IR) may be used to communicate with a primary remote control used with the television device to control the control unit of the communication system, for example to accept or decline an incoming call. The primary remote control may be the television remote control or a remote control of a secondary device connected to the television, such as a satellite television set-top box remote control or DVD player device remote control or other such devices. In this arrangement, the receiving person is not required to learn the functioning of a new remote and may use the controls on an existing known remote control device. The simplicity of using an existing remote control facilitates the ease of use for set-up and use of the communication system for the receiving person.

The control unit may include a storage medium (e.g., a hard drive, random access memory (RAM), etc.) on which is encoded (perhaps among other data) instructions executable by a processor(s) to control operation of the communication system.

In some forms, the communication system can receive a message sent from other users to the control unit using web-based interfaces. A message may include one or more of notifications, alerts, reminders, documents, images, audio or video calls. When the control unit receives the message the control unit communicates with the television. If the television is off or in an inactive state, the control system will turn on or activate the television and switch the input channel to a desired channel to enable display of the message. If the television is on or in an active state, the control system may automatically change or switch the input channel to a desired channel to enable display of the message. In another example, if the television is already on and for specific types of messages, such as a written message (e.g. an alert or reminder), then the message may be displayed on the existing channel on a portion of the television screen. The control unit may note or record the current state of the television as a first state prior to the call to enable the control unit to switch the television back to the first state after the message is completed.

In some forms, the control unit requires the receiving person to accept the message prior to display of the message. The receiving person may accept the call by pressing a first button on the primary remote control device, for example a green button. Alternatively, if the receiving person decides to decline the call, they may press a second button on the primary remote control device, for example a red button. Although it is to be understood that other buttons on the remote control may be utilized to accept or decline the message.

As one example, a button which is designated for acceptance of a message could be provided with a green sticker on the button or adjacent to the button. Similarly, a red sticker could be provided on or adjacent to a button which is provided for declining a message or terminating a communications session. Alternatively, a button on the existing remote control which already has the desired green or red color could be designated as the button for initiating or terminating a message or conversation session.

Other colors could alternatively be utilized or other coding systems other than color could be utilized, such as symbols or word labels placed upon the familiar remote control, or conveniently repurposed from the existing remote control. As one example, when a message is coming in, the message can be received by pushing any buttons which are in the form of an arrow pointing upward, such as a “volume up” button or a “channel up” button, and any arrow pointing downward could be selected to cause a message to be declined, including a “volume down” button or a “channel down” button. When a message is received, remote control would have these existing buttons repurposed so that they do not provide their previous function (e.g. changing volume or changing channels), but rather would allow for accepting or declining a message or communication session. After an appropriate button has been selected, the communication system would cease repurposing of these buttons of the remote control so that they would return to their original function.

Repurposing of the remote control could occur, in one embodiment, as follows. The remote control for the television set and the television set would operate normally until a message or an invitation for a communications session is received by the communication system. When such an invitation is received by the control unit or other portion of the communication system, assuming the system is set up to allow the receiving person to accept or decline the message or communication session. The control unit or other portion of the communication system, through integration with the television set, would prevent the television set from functioning according to normal operation, but instead would “listen” for selection of the appropriate button (or buttons) on the remote control. If the appropriate button for accepting the message or communication session is depressed, a message or communication session is initiated. If the appropriate button to decline the message or communication session is depressed, the message or communications session would be declined and the television set would return to normal operation. Such temporary reprogramming of the television set would typically occur through the HDMI ports and an appropriate cable between the control unit and the television set, or according to other techniques known in the art.

In other forms, the receiving person may accept or decline a message by speaking a command such as saying “hello” or “yes” to accept or “no” to decline. As will be appreciated, other predetermined or specified vocal commands may be used.

In other forms, the control unit automatically accepts the message and displays the message on the desired channel of the television. The control unit may be configured to automatically accept and display some types of messages whilst other types of messages may require acceptance by the receiving person before the message is displayed. For example some alerts, reminders or notifications may be displayed automatically. A reminder to take medication may automatically be accepted and displayed. In some circumstances the message may require a response to be provided to confirm that an action has occurred or that the receiving person is ok.

The control unit may be configured remotely by the administrator to select the types of messages that may be automatically accepted. Particular users may be set-up to enable automatic acceptance of some or all of the messages or particular types of messages that they may send to the receiving person. The types of messages may include one or more of a reminder, alert or notification message, audio call, video call or other types of messages.

In some forms, if a message is not answered within a predetermined period of time, the message may be declined. For example, if the television was previously off or in an inactive state before the control system had turned on the television, then the television may remain on for a predetermined period of time in the absence of any interaction with the control system. After the predetermined time has been reached without interaction with the control system, the control unit may turn off the television, returning it to its pre-existing state. The interaction with the control system may be by the receiving person or another user at a remote location.

After a message is accepted either manually or automatically, the message will be displayed on the television. For example, messages including a real-time video call may be initiated between at least one user (or caller) and the receiving person with the at least one user being displayed in real-time (i.e. visible) to the receiving person on the television if the user has a camera coupled to the web enabled interface device that they are using to send the message. If the control unit of the communication system includes a camera then the at least one user will also be able to see the receiving person.

In some forms, the at least one user may be able to take control of the communication system to show or identify specific documents or files to the receiving person and/or other users that are on the current call.

The communication system may allow more than one user at a time, the control unit is configured to allow multiple inputs of multiple media. When multiple users are using the system, each user may share folders according to levels of access granted. Some folders may be categorized as private folders that only specific people can access and see. In some circumstances, if a message or call is already occurring with one or more users, who is part of a first collaboration group, and a second user, who is not part of the first collaboration group but part of a second collaboration group, attempts to make a call, the second user may receive a message saying the control unit is busy and/or the control unit may display a message that the second user is attempting to send a message. Optionally one or more users of the first collaboration group may be enabled to add the second user to the first collaboration group and consequently join the communication or call, if desired.

In some forms, users may upload some messages or files to the control unit for later viewing or display by the receiving person. The upload messages may be stored in a storage medium of the control unit for display at a predetermined or preselected time or after acceptance by the receiving person. The stored messages and files may remain stored on the control unit until they are deleted or removed. For example, in some embodiments family members may upload photographs and/or written messages to the control unit. For example, the photographs and/or written messages may be displayed as a slideshow for a predetermined period of time after the television is switched off using the remote control. Alternatively, a button on the primary remote control may be configured to enable display of the saved messages.

Upon initial control unit set up, and provided one or more users have previously accepted invitations to join the communication system, then any images or information that the one or more users have uploaded to the system may automatically be displayed on the connected television upon completion of set-up. The images may remain as part of slide show that may be accessed when desired.

An example of two ways that the operation may be controlled include: (1) the information can be automatically uploaded and stored on the TV and the receiving person can switch to the channel to access; or (2) the user can call and instantly tune into the TV and require a response. In such circumstances having to receive a response may assist in ensuring compliance and/or adherence to a particular program or plan as the receiving person will have to respond to be able to switch back to continue to watch the TV.

In some forms, the control unit may be configured to save, file, record or store the messages that have been sent to a file. The saved, filed, recorded or stored messages may be sent to other users for their records also. For example, a copy of the saved, filed, recorded or stored message with a health professional may be sent to the health professional for storage in appropriate files.

If a message is declined then the control unit may recall the first state that the television was in prior to the call and switch the television back to that state. If the television was off or in an inactive state, the control system will turn off the television. If the television was on then the control unit may automatically change or switch the channel back to the previous channel that was on the television. This results in the receiving person not having to take any actions to return the television back to the first state.

As the control unit may record information about the current state of the television when messages are initiated, the control unit may be configured to record what is being watched on the television. The usage data may be used for marketing or research purposes. In some forms, the control unit may continuously monitor the usage of the television viewing including such parameters as time, channels, program information, applications used on the television or any other information that may relate to the television usage.

Advantageously, the simplicity of the communication system provides portability of the control unit to enable plug and play at any location. For example, a person may take the control unit when traveling, especially if internal internet capability is provided within the control unit. In another example, a health professional, such as a nurse, may take a control unit along when visiting clients or patients. During the visit the health professional may connect the control unit to a television and a power source if needed to enable communication to other interested parties such as other health professionals (e.g. doctors) or family members or both. This may be beneficial in a number of situations. For example, if the health conditions of the client or patient have changed and require further medical input or the health professional wants to update the doctor or family or both at the same time, such action is facilitated.

In some forms, the communication system may be used to assist others with performing other activities such as online shopping, ordering taxis or booking other services. In some forms third party businesses may be approved and added as users of the communication system and would then be able to go to the receiving person to provide virtual assistance rather than waiting for users to come to them. This may provide new marketing opportunities for businesses.

In some circumstances, the control unit may be configured to communicate with one or more secondary devices. The one or more secondary devices may include a medical device, wearable devices or similar types devices. Examples of a medical device that may communicate with the control unit may include a pacemaker, insulin pump, blood pressure monitor, electronic scales or other such devices. Example of wearable devices may include a watch, fitness monitor, or health monitoring device. The control unit may be configured to provide alerts if one or more of the secondary devices is not within a normal range or a potential health issue may be occurring. In some circumstances the control unit may send a message to one or more of a health professional, emergency agency (e.g. ambulance or police), family member or selected person(s).

In some embodiments, the control unit may be designed to attach to a television or to be self-supporting on a surface such as a table or both. The control unit may include a main component designed to contain the electronic components of the control unit. For example, the main component may include one or more of an internet enabling device (e.g. 3G or 4G dongle), wiring, microprocessor, USB WiFi adaptor, power supply, memory device, infrared (IR) sensor (for example an IR transmitter, an IR receiver, or an IR transceiver), connector ports, microphone and camera. One or more connector ports may be exposed on the outer surface of the main component and be configured to couple with cabling, such as an HDMI cable. In alternative forms, the camera may be housed in a separate camera component that is coupled to the main component.

In one arrangement, the main component has a generally rectangular shape with curved or rounded corners, but as would be understood by a skilled addressee, the main component may be made in any shape including square, triangular, curved or any other desired shape. The main component may include an outer housing surrounding the internal electronic components. The outer housing may include one or more cooling vents to allow the heat from the electronic components to be dissipated. The cooling vents may be arranged on any outer surface of the housing.

If the control unit includes a camera, the camera may be located on a front surface of the main component to ensure the camera can view the room. Alternatively, the camera component may be coupled to a front surface of the main component. The angle of the camera may be adjustable by directly moving a portion of the camera. Alternatively, the camera angle may be adjusted by adjusting the position and angle of the main component.

In an exemplary embodiment, the main component is pivotally coupled to a stand component configured to move between two or more positions. The pivotal coupling may be via a stiff hinged connection between the main component and the stand component, enabling repositioning and to hold position however it is oriented.

In a first position, the stand component may be configured to support the main component on a substantially flat surface such as a table or bench. In a second position, the stand component is configured to support the main component on a television, such as above the television screen. In the second position, the stand component may sit behind the television and the main component may sit on top of the television. Preferably, the stand is configured to fit behind any television including a wall mounted television, for example the stand component may have a slim configuration.

In some configurations, the stand component may also move to a third position configured for transport. In the third position, the stand component may cover the front surface of the main component including the lens of the camera. In this arrangement, the stand component functions as a lens cap to protect the camera during storage and transport. The stand component may protect other components of the control unit when in the third position. The third position may be considered a fully closed position.

The stand component may be moveable or adjustable into a plurality of positions between the first position and the second and/or between the first or second position and the third position. Preferably the stand component is fully adjustable between the fully closed position and a fully open position and all positions there between. The position adjustment may assist in providing a range of camera viewing angles by tilting the camera into the different positions. A series of images of representative devices are included in FIGS. 6-1 to 10-3.

The control unit preferably has a small size to facilitate portability of the system. For example, it may have dimensions of approximately 75 mm to 100 mm in width, 150 mm to 200 mm in length and 20 mm to 50 mm in height.

The communication system may be used by any person. The ease of use makes the system suitable for use by everyone at any location. For example, the communication system may help fill some disability or knowledge gaps such as problems with small text on smart phones, fear of new technology, and being visually impaired friendly due to using the large display size of a television screen. The communication system may also be used to help monitor people in assisted living arrangements, for telemedicine and even to assist with home detention monitoring.

For a firmware and/or software (also known as a computer program) implementation, the techniques of the present disclosure may be implemented as instructions (for example, procedures, functions, and so on) that perform the functions described. It should be appreciated that the present disclosure is not described with reference to any particular programming languages, and that a variety of programming languages could be used to implement the present invention. The firmware and/or software codes may be stored in a memory, or embodied in any other processor readable medium, and executed by a processor or processors. The memory may be implemented within the processor or external to the processor.

A general purpose processor may be a microprocessor, but in the alternative, the processor may be any suitable processor, controller, microcontroller, or state machine. A processor may also be implemented as a combination of computing devices, for example, a combination of a digital signal processor (DSP) and a microprocessor, a plurality of microprocessors, one or more microprocessors in conjunction with a DSP core, or any other such configuration. The processors may function in conjunction with servers and network connections as known in the art.

The steps of a method, process, or algorithm described in connection with the present disclosure may be embodied directly in hardware, in a software module executed by one or more processors, or in a combination of the two. The various steps or acts in a method or process may be performed in the order shown, or may be performed in another order. Additionally, one or more process or method steps may be omitted or one or more process or method steps may be added to the methods and processes. An additional step, block, or action may be added in the beginning, end, or intervening existing elements of the methods and processes.

The above and other features will become apparent from the following description and the attached drawings.

### BRIEF DESCRIPTION OF THE DRAWINGS

The detailed description of the drawings refers to the accompanying figures in which:

FIG. 1 illustrates an exemplary communication system according to one aspect of the present disclosure;

FIG. 2 is a schematic diagram of an exemplary control unit for use in the exemplary communication system;

FIG. 3 is a flow diagram illustrating an exemplary registration process for the control unit;

FIG. 4 is a flow diagram illustrating an exemplary configuration process for the control unit;

FIG. 5-1 is a flow diagram illustrating an exemplary method of operating the communication system;

FIG. 5-2 illustrates a first exemplary user interface of the communication system;

FIG. 5-3 illustrates a second exemplary user interface of the communication system;

FIG. 6-1 is a perspective view of a first exemplary embodiment of the control unit;

FIG. 6-2 is a lower elevation view of the first exemplary embodiment of the control unit;

FIG. 6-3 is a side view of the first exemplary embodiment of the control unit;

FIG. 6-4 is a front view of the first exemplary embodiment of the control unit;

FIG. 6-5 is a side view of the first exemplary embodiment of the control unit in a television mounting mode;

FIG. 6-6 is a perspective view of the first exemplary embodiment of the control unit in a stored mode;

FIG. 7-1 is a perspective view of a second exemplary embodiment of the control unit in a table-top mode.

FIG. 7-2 is a perspective view of the second exemplary embodiment of the control unit in a television mounting mode;

FIG. 8-1 is a perspective view of a third exemplary embodiment of the control unit in a television mounting mode;

FIG. 8-2 is a perspective view of the third exemplary embodiment of the control unit in a table-top mode;

FIG. 9-1 is a perspective view of a fourth exemplary embodiment of the control unit in a television mounting mode;

FIG. 9-2 is a perspective view of the fourth exemplary embodiment of the control unit in a table-top mode;

FIG. 10-1 is a perspective view of a fifth exemplary embodiment of the control unit in a connected state;

FIG. 10-2 is a perspective view of the fifth exemplary embodiment of the control unit in a disconnected state;

FIG. 10-3 is a perspective view of the fifth exemplary embodiment of the control unit in a television mounting mode.

### DETAILED DESCRIPTION OF THE DRAWINGS

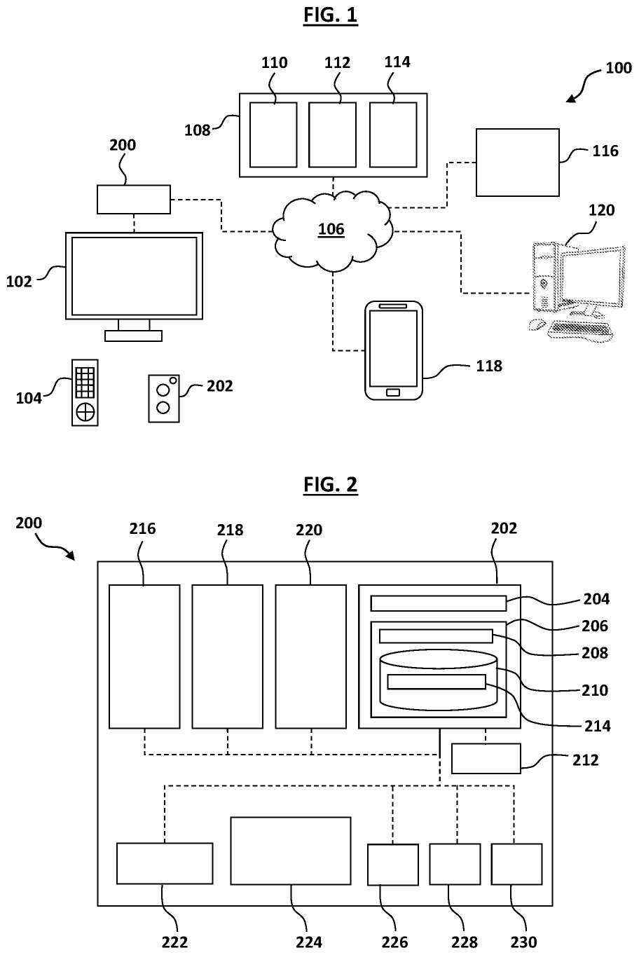

FIG. 1 illustrates an exemplary embodiment of a communication system 100 within which the present disclosure may operate. Within the system 100, a control unit 200 is associated with a television 102 (although it should be appreciated that use with other display devices is contemplated) having a television remote control unit 104. In an exemplary embodiment, the control unit 200 may have an associated remote control 202. The control unit 200 is configured to communicate over via a network 106, the network 106 potentially comprising various configurations and protocols including the Internet, intranets, virtual private networks, wide area networks, local networks, private networks using communication protocols proprietary to one or more companies—whether wired or wireless, or a combination thereof.

Within the system 100, the control unit 200 communicates with a communication facilitation and management service 108, illustrated in this exemplary embodiment as being implemented in a server—for example one or more dedicated server devices, or a cloud based server. In the exemplary embodiment illustrated, the communication facilitation and management service 108 includes three modules or server functions: a signaling server 110 configured to facilitate the transmission of communications to and from the control unit 200, a web server 112 managing user account settings and details and provision of web based interfaces, and a Traversal Using Relays around NAT (TURN) server 114 configured to assist in traversing network address translators (NAT) or firewalls for establishing communications. The communication facilitation and management service 108 may also include one or more application programming interface (API) modules for communication with third party service providers 116.

The system 100 also includes user devices for communicating with the user of the control unit 200 via the associated television 102—for example a smart device 118 such as a mobile phone or tablet operating an communication application for the communication system 100, or an internet enabled device 120 capable of accessing a web portal for the communication system 100.

Referring to FIG. 2, the control unit 200 includes a controller 202. In the exemplary embodiment illustrated, the controller 202 has a processor 204, memory 206, and other components typically present in such computing devices. In the exemplary embodiment illustrated the memory 206 stores information accessible by processor 204, the information including instructions 208 that may be executed by the processor 204 and data 210 that may be retrieved, manipulated or stored by the processor 204. The memory 206 may be of any suitable means known in the art, capable of storing information in a manner accessible by the processor 204, including a computer-readable medium, or other medium that stores data that may be read with the aid of an electronic device. It is also envisaged that the control unit 200 may include an additional memory 212—for example for long term storage of memory intensive data such as images and video.

The processor 204 may be any suitable device known to a person skilled in the art. Although the processor 204 and memory 206 are illustrated as being within a single unit, it should be appreciated that this is not intended to be limiting, and that the functionality of each as herein described may be performed by multiple processors and memories, that may or may not be remote from each other.

The instructions 208 may include any set of instructions suitable for execution by the processor 204. For example, the instructions 208 may be stored as computer code on the computer-readable medium. The instructions 208 may be stored in any suitable computer language or format. Data 206 may be retrieved, stored or modified by processor 204 in accordance with the instructions 208. The data 210 may also be formatted in any suitable computer readable format. Again, while the data 210 is illustrated as being contained at a single location, it should be appreciated that this is not intended to be limiting—the data 210 may be stored in multiple memories or locations. The data 210 stored on server may include a record of control routines 214 for the control unit 200, as described further below.

The control unit 200 includes a power supply 216, for example configured to be connected to an external power source (although it is envisaged that in exemplary embodiments the power supply may include onboard power source such as a battery). A communications module 218 is provided for connection to the network 106, and/or to a wireless communications module of the television 102—for example including one or more of a telecommunications network connection (such as a cellular module), and a local network communications device (whether via a wireless communication protocol such as Bluetooth or WiFi, or a wired connection such as ethernet). Connector ports 220 are also provided—including a connection port for connection to the television (whether directly or via an intermediary device such as a set-top device), such as a port for connection to a Consumer Electronics Control (CEC) bus in communication with the television.

In exemplary embodiments, the control unit 200 further includes an infrared (IR) sensor 222. In an exemplary embodiment, the IR sensor 222 may be a receiver, configured to receive IR signals from the remotes 104 and/or 202. In an exemplary embodiment, the control unit 200 may be programmed to process a plurality infrared remote control protocols, enabling commands to be received from television remote controls from a range of manufacturers having different protocols.

In an exemplary embodiment, the IR sensor 222 may be configured as a transceiver, enabling communication with an IR sensor of the television 102. For example, the control unit 200 may issue commands to the television set 102 using infrared remote control protocols. It is envisaged that this may have particular application to use of the control unit with models of television which are not enabled for control protocols such as CEC. In an exemplary embodiment, the control unit 200 may be configured to be programmed with infrared remote control codes specific to the television set 102, whether via pre-programming, via the connection to the network 106, or using the television remote control 104 itself (as known in relation to the programming of universal remote controls).

In exemplary embodiments, the control unit 200 includes a camera 224. As will be described further below, the camera 224 may be integral with a housing of the control unit 200, or may be a separate unit in communication with a base unit of the control unit 200.

In exemplary embodiments, the control unit 200 may further include one or more of: a microphone 226, a speaker 228 for issuing audible alerts or notifications, and one or more light devices 230 (such as an LED).

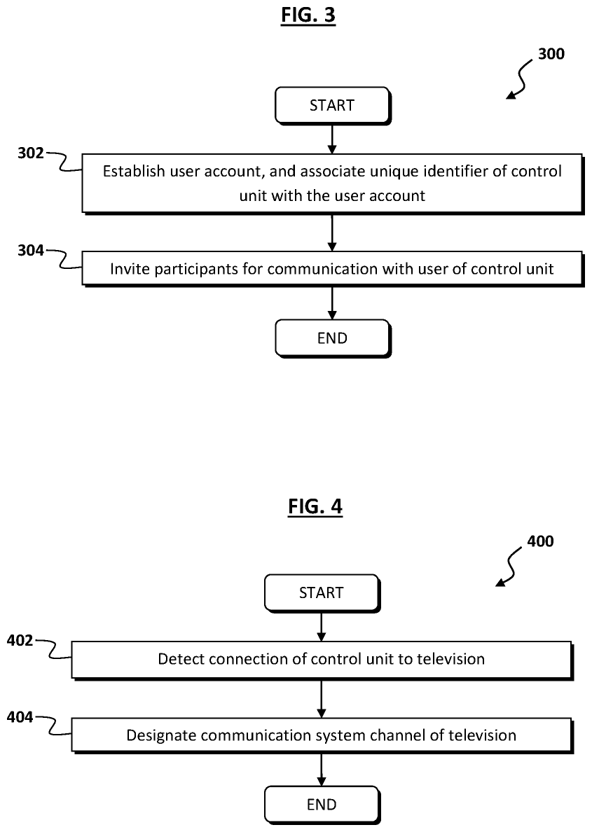

Referring to FIG. 3, in an exemplary embodiment a registration process 300 is performed prior to use of the communication system 100. It is envisaged that each control unit 200 may have an associated unique identifier, used to direct communications to and from that control unit 200. In the registration process 300, a user account is established in step 302 and the unique identifier associated with the user account. In step 304, participants for communication with the end user of the control unit 200 are invited to become associated with the user account. For example, participants may be invited by way of their email address, or telephone number. Those participants may be allocated unique user identifiers in order to identify the respective participants for communications to and from those participants. In an exemplary embodiment, the registration process 300 may be performed prior to connection of the control unit 200 to the end user's television 102—for example by an administrator via a registration website provided by the communication facilitation and management service 108 and accessed via a user device 118 or 120. In an exemplary embodiment, the registration process 300 may be performed on initialization of the control unit following connection to the user's television.

Referring to FIG. 4, in an exemplary embodiment a configuration process 400 may be performed on connection of the control unit 200 to the television 102. In step 402, connection of the control unit 200 to the television 102 may be detected—for example via an HDMI connection allowing access to CEC protocol. In step 404, a channel of the television 102 may be designated as a communication system channel, for use by the system 100 in displaying or otherwise communicating messages via the television 102. In an exemplary embodiment, during the configuration process, commands for the control unit 200 may be allocated to a button, or buttons, of the television remote control 104 for use with the television 102.

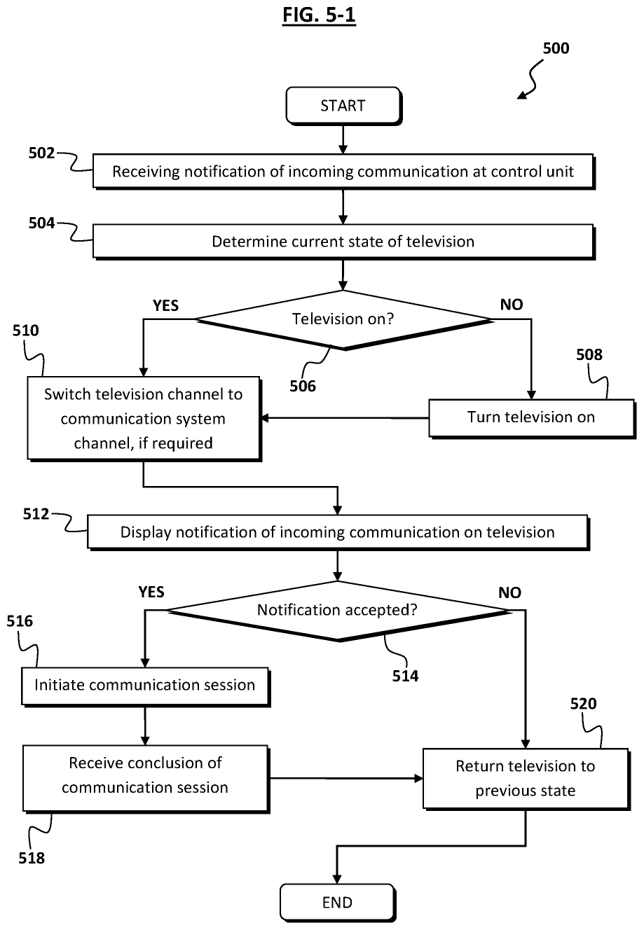

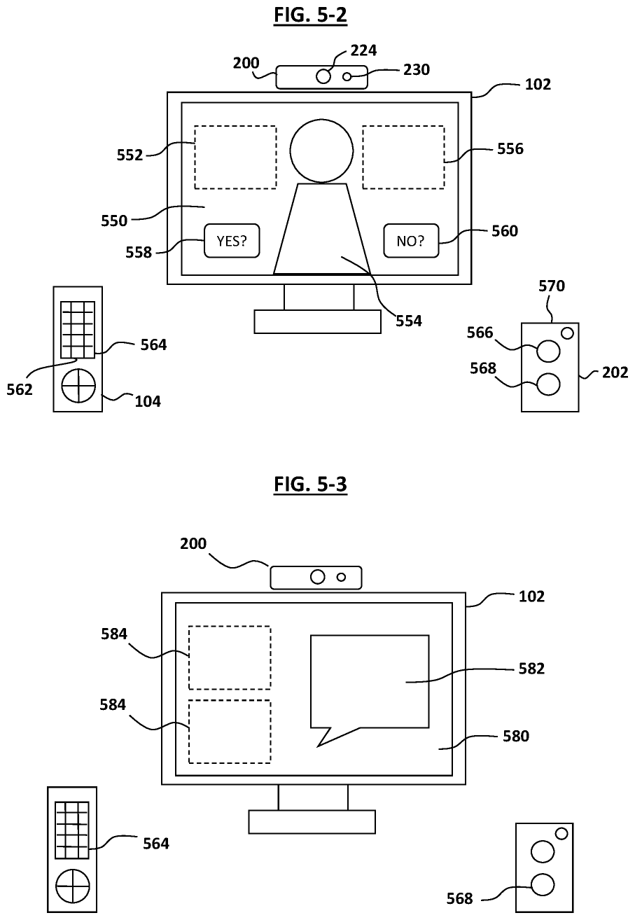

FIG. 5-1 illustrates an exemplary method 500 of operation of the communication system 100. In step 502, the communication system 100 receives a notification of an incoming communication sent from other users to the control unit 200, for example using an app of the mobile phone 118 or web-based portal accessed using device 120. The incoming communication may include a message, and more particularly may include one or more of notifications, alerts, reminders, documents, images, audio or video calls.

In step 504 the control unit 200 communicates with the television 102 to determine the current state of the television 102. More particularly, a determination is made in step 506 as to whether the television 102 is on. If not, in step 508 the control unit 200 turns on the television 102, and in step 510 switches the current channel to the communication system channel, if required. If the television 102 is determined to already be on in step 506, step 510 is performed—i.e. the control unit 200 switches the current channel to the communication system channel, if required.

In step 512 a notification of the incoming communication is displayed on the television 102. Referring to FIG. 5-2, in an exemplary embodiment in which the incoming communication is a call, an incoming call user interface 550 may be displayed. The incoming call interface 550 may include an identifier 552 of the calling party, for example a text based identifier such as a name. In an exemplary embodiment in which the user initiating the call has a camera coupled to the device 118 or 120, an image or video 554 of the caller may be displayed. In an exemplary embodiment, the incoming call interface 550 may include visual guidance 556 for options available to the receiving person (whether textual or pictorial).

In an exemplary embodiment, the incoming call interface 550 may include a first graphical prompt 558 to accept the call, and a second graphical prompt 560 to decline the call. In an exemplary embodiment, the graphical prompts 558 and 560 may be colour coded—for example to match first and second buttons 562 and 564 of the television remote control 104, or first and second buttons 566 and 568 of the control unit remote control 202. In another embodiment, the graphical prompts 558 and 560 may include numerals, text, or symbols matching those of the first and second buttons 562 and 564 or first and second buttons 566 and 568.

In an exemplary embodiment, in addition to the display of the incoming call user interface 550 the communication system 100 may perform one or more of: activating the LED 230 of the control unit 200, activating a remote LED 570 on the control unit remote control 202, issuing an audible alert via the television 102 or speaker 228 of the control unit.

In another example, if the television 102 is already on and for specific types of messages, such as a written message (e.g. an alert or reminder), then the message may be displayed on the existing channel on a portion of the television screen.

Returning to FIG. 5-1, in step 514 the control unit 200 monitors for user input regarding a desired action for the communication. In some forms, the control unit 200 requires the receiving person to accept the message prior to display of the message. The receiving person may accept the call by pressing the first button 562 on the television remote control device 102, or the first button 566 on the control unit remote control 202. Alternatively, if the receiving person decides to decline the call, they may press the second button 564 on the television remote control device 102, or the second button 568 on the control unit remote control 202.

As one example, when a message is coming in, the message can be received by pushing any buttons which are in the form of an arrow pointing upward, such as a “volume up” button or a “channel up” button, and any arrow pointing downward could be selected to cause a message to be declined, including a “volume down” button or a “channel down” button. When a message is received, remote control 104 would have these existing buttons repurposed so that they do not provide their previous function (e.g. changing volume or changing channels), but rather would allow for excepting or declining a message or communication session. After an appropriate button has been selected, the control unit 200 would cease repurposing of these buttons of the remote control 104 so that they would return to their original function.

Repurposing of the remote control could occur, in one embodiment, as follows. The remote control 104 for the television 102, and the television 102, would operate normally until a message or an invitation for a communications session is received by the control unit 200. When such an invitation is received by the control unit 200 (or other portion of the communication system 100), the control unit 200 through communication with the television 102, would prevent the television 102 from functioning according to normal operation, but instead would “listen” for selection of the appropriate button (or buttons) on the remote control 104. If the appropriate button for accepting the message or communication session is depressed, a message or communication session is initiated. If the appropriate button to decline the message or communication session is depressed, the message or communications session would be declined and the television 102 would return to normal operation.

In an exemplary embodiment, the receiving person may accept or decline a message by speaking a command such as saying “hello” or “yes” to accept or “no” to decline (although it will be appreciated that other predetermined or specified vocal commands may be used)—to be detected by the microphone 226 of the control unit 200. In another exemplary embodiment, gestures may be detected by the camera 224 and interpreted as accepting or declining the message.

In other forms, the control unit 200 automatically accepts the message and displays the message on the desired channel of the television 102. The control unit 200 may be configured to automatically accept and display some types of messages whilst other types of messages may require acceptance by the receiving person before the message is displayed. For example, some alerts, reminders or notifications may be displayed automatically. A reminder to take medication may automatically be accepted and displayed. In some circumstances, the message may require a response to be provided to confirm that an action has occurred or that the receiving person is ok. The control unit 200 may be configured remotely by an administrator to select the types of messages that may be automatically accepted. Particular users may be set-up to enable automatic acceptance of some or all of the messages or particular types of messages that they may send to the receiving person. The types of messages may include one or more of a reminder, alert or notification message, audio call, video call or other types of messages.

On acceptance (whether initiated by the receiving person or automatically by the control unit 200), the communication session is initiated in step 516—whether that be display of a visual message, image, or video, a voice communication session, or a video communication session. For example, messages including a real-time video call may be initiated between at least one user (or caller) and the receiving person with the at least one user being displayed in real-time (i.e. visible) to the receiving person on the television 102 if the user has a camera coupled to the device 118 or 120 that they are using to send the message. If the control unit 200 of the communication system includes a camera 224 then the at least one user will also be able to see the receiving person.

FIG. 5-3 illustrates an exemplary graphical message display 580, in which a text based message 582 may be displayed, and/or images or one or more pre-recorded videos 584 displayed.

In an exemplary embodiment, the communication session may include the presentation of one or more questions to the receiving person, and prompting the receiving person to input an answer using the television remote control 104. For example, multiple choice answers may be presented with an associated numeral from between 0 to 9, and selection of a channel button on the remote control 104 during the communication session may be interpreted as selection of the associated answer. As another example, the question may prompt an answer on a scale between 0 to 9. It is envisaged that this may be used, for example, to conduct a remote health assessment of the receiving person. Where such an assessment is performed automatically by the communications system 100, certain answers may trigger further actions—for example prompting contact or intervention by a support person or clinician.

On receiving an indication of the message or communication session being concluded (for example, by the initiating user, or the receiving person via remote control 104 or 202) in step 518, the control unit 200 returns the television 102 to its previous state from before receiving the communication in step 520. Similarly, if the communication is declined in step 514, the control unit may perform step 520. In some forms, if a notification of an incoming message is not answered within a predetermined period of time, the message may be declined automatically.

In step 520, the control unit 200 may return the television 102 to its previous state before receiving the communication. For example, if the television 102 was in an off state, the control unit 200 may turn the television off (or request confirmation from the user that this should be done). If the television 102 was on or in an active state, the control unit 200 may automatically switch the television back to the channel which was displayed prior to receiving the communication.

Several embodiments of the form of the control unit 200 are described herein. General considerations for the physical embodiment of the control unit may include: different use case scenarios (for example positioning on the television 102, and/or self-supporting on a table top), ease of use in terms of positioning and use, relatively small size and weight for ease of positioning and aesthetic purposes. In exemplary embodiments including a camera 224, it may be desirable to position the camera in a central position for intuitive operation.

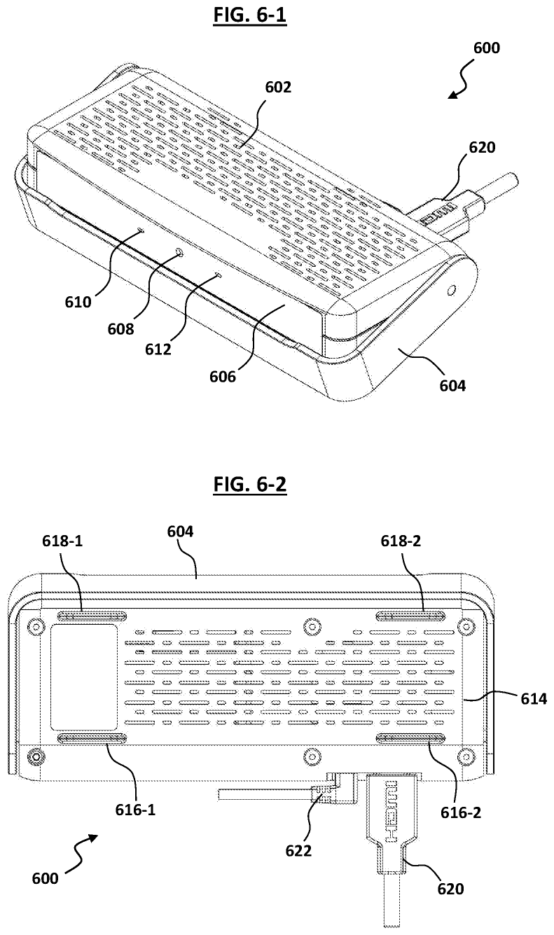

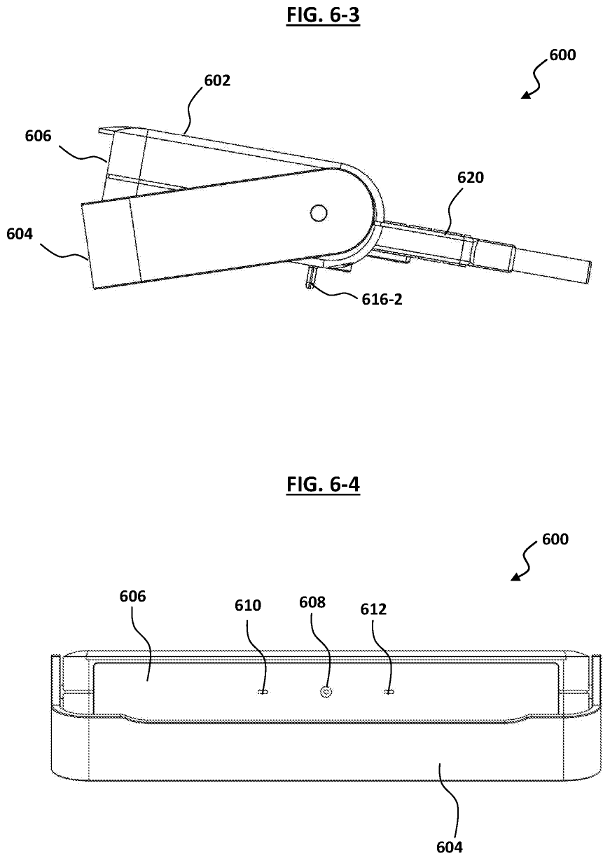

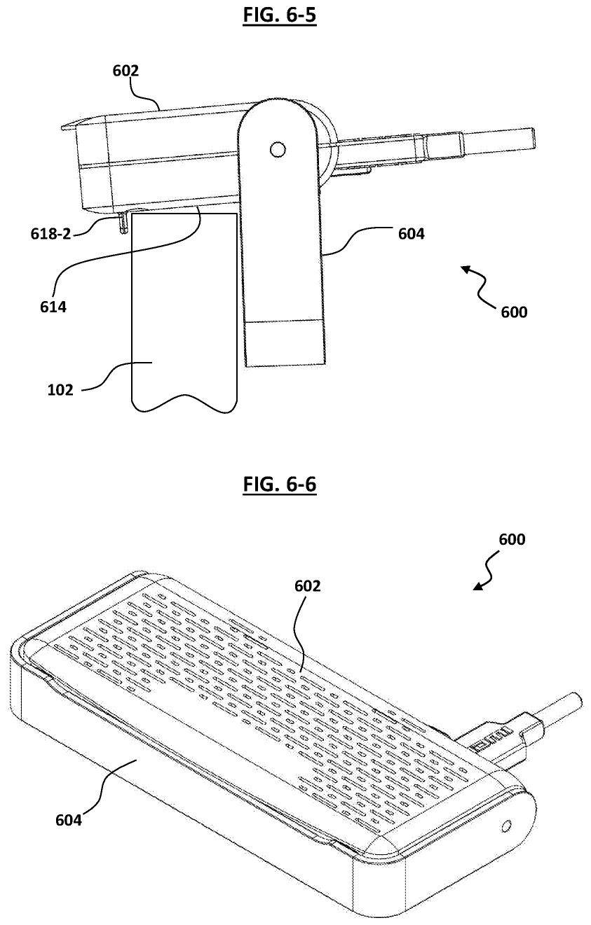

FIG. 6-1 to FIG. 6-6 illustrate an exemplary control unit 600. Referring to FIG. 6-1, the control unit 600 includes a main housing 602, and a stand component in the form of stand arm 604 pivotally attached to the sides of the main housing 602. In an exemplary embodiment, the pivotal connection may be provided by constant torque hinges, such that the angle of the main housing 102 relative to the stand arm 604 is maintained until force is applied by a user to move them. On a front surface 606 of the main housing 602, camera aperture or lens 608, IR sensor aperture 610 and LED aperture 612 are provided for access to the camera 224, IR sensor 222, and LED 230 respectively. In FIG. 6-1, the control unit 600 is illustrated in a table-top mode, with the front surface 606 elevated above the stand arm 604.

Referring to FIG. 6-2, the control unit 600 has a base surface 614 from which rear stand legs 616-1 and 616-2, and front stand legs 618-1 and 618-2, extend. Referring to FIG. 6-3 and FIG. 6-4, in the table-top mode the control unit 600 rests on the stand arm 604 and rear legs 616-1 and 616-2 with the front surface 606 elevated above the stand arm 604. FIG. 6-4 also shows the camera aperture or lens 608, IR sensor aperture 610 and LED aperture 612 on the front surface 606. Returning to FIG. 6-2, a wired connection to television 102 (for example HDMI cable 620) is input into an associated port at the rear of the main housing 602, and an antenna 622 is also provided for the communications module 218.

In FIG. 6-5, the control unit 600 is illustrated in a television mounting mode, in which the control unit 600 is placed on the top of a television 102, with front stand legs 618-1 and 618-2 extending over a front lip of the television 102, and the stand arm 604 pivoted down to brace against the rear of the television 102 to hold the control unit 600 in place. In this position, the main housing 602 is above the television 102, rather than behind, which is envisaged as assisting with heat dissipation from the associated electronics—as temperatures behind the television are typically elevated. In an exemplary embodiment, the base surface 614 and/or front stand legs 618-1 and 618-2 may include a tactile surface treatment to improve grip against the television 102.

FIG. 6-6 illustrates a stored mode of the control unit 600—whether for transportation of the unit 600, or when not in use on a table top. The support arm 604 is pivoted upwardly from the table-top mode to cover the front surface 606. It is envisaged that this may have particular use in protecting the camera lens 608 when the control unit 600 is not in use.

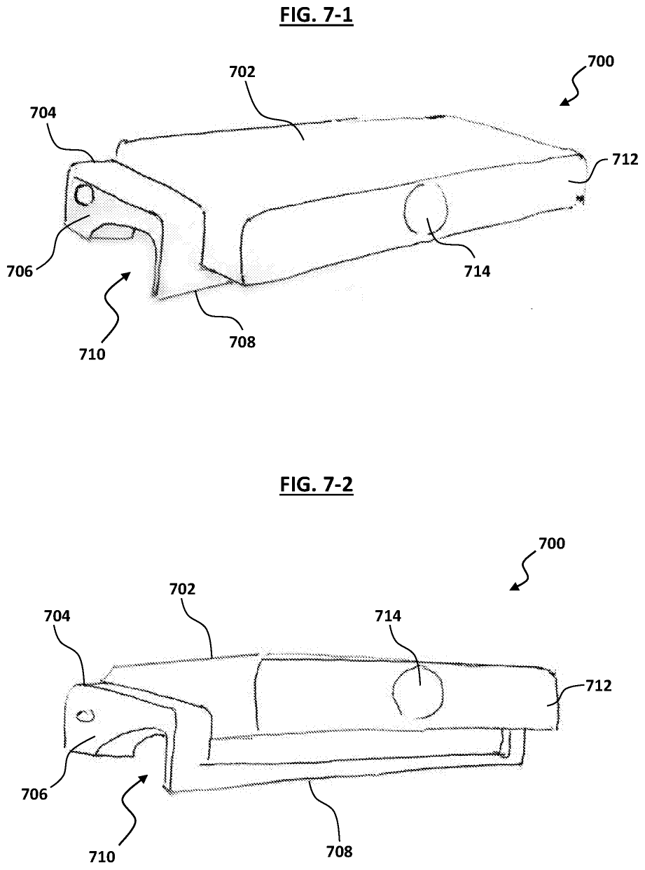

FIG. 7-1 and FIG. 7-2 illustrate another exemplary control unit 700. Referring to FIG. 7-1, the control unit 700 includes a main housing 702, and a stand component in the form of stand arm 704 having side arms 706 pivotally attached to each side of the main housing 702 (only one arm shown), and a cross member 708 extending between the side arms 706, below the main housing 702. In an exemplary embodiment, the pivotal connection may be provided by constant torque hinges. The side arms 706 each include a downward facing recess 710, such that the side arms 706 form hooks. In a table-top mode, as shown in FIG. 7-1, the control unit 700 may be configured such that the main body 702 rests on the cross member 708 (or lifted to a desired angle). In this mode, the control unit 700 is supported on a surface by the cross member 708 and rear portions of the side arms 706. A front surface 712 of the main housing 702 faces forward, with a camera aperture or lens 714 located centrally on the front surface 712. It should be appreciated that while features such as the IR sensor are not illustrated in the figures accompanying exemplary embodiments of the control unit, this is not intended to be limiting.

In a television mounted mode, as shown in FIG. 7-2, the control unit 700 may be positioned on top of television 102, with the cross member 708 extending over a front lip of the television 102 and the upper portion of the television located within the recesses 710. In an exemplary embodiment, the downward facing surfaces of the recesses 710 may include a tactile surface treatment to improve grip against the television 102. The main housing 702 may be pivoted relative to the stand arm 704 to achieve a desired angle while mounted on the television 102.

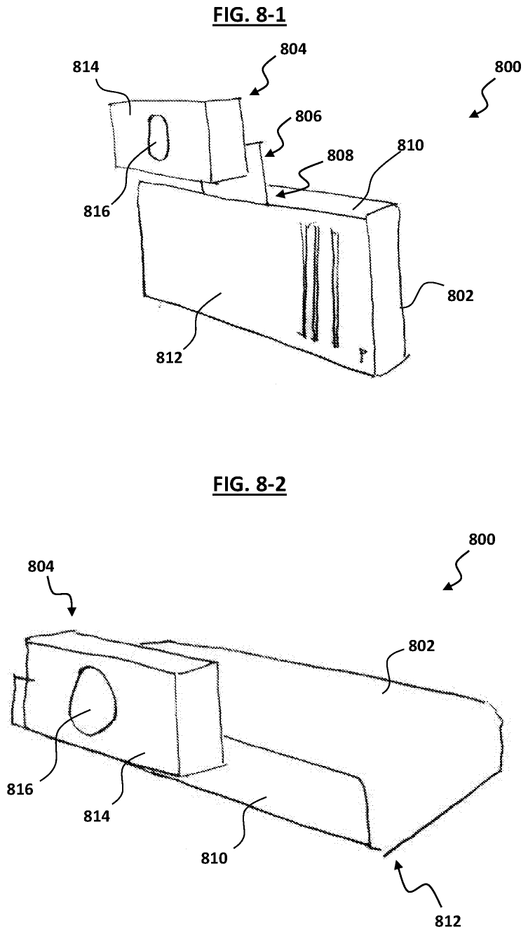

FIG. 8-1 and FIG. 8-2 illustrate another exemplary control unit 800. Referring to FIG. 8-1, the control unit 800 includes a main housing 802, and a secondary housing 804. The secondary housing 804 is connected to the main housing 802 by a bracket member 806 (in this exemplary embodiment an “L” shaped bracket member), pivotally connected to the main housing 802 at the main housing end 808 of the bracket member 806.

The pivoting bracket member 806 allows the secondary housing 804 to be transitioned between a television mounted mode (as shown in FIG. 8-1), and a table-top mode (as shown in FIG. 8-2). In the television mounted mode, the bracket member 806 is pivoted away from a first surface 810 of the main housing 802 such that the secondary housing 804 projects forward from a second surface 812 of the main housing 802. In the television mounted mode, a front surface 814 of the secondary housing 804 (in which a camera aperture or lens 816 is centrally located) faces in the same direction as the first surface 812. Control unit 800 may be mounted on the top of the television 102, with the secondary housing 804 (or a catch member extending from the bracket member 806) extending over a front lip of the television 102, and the second surface 812 of the main housing 802 resting against the rear of the television 102.

In the table-top mode shown in FIG. 8-2, the bracket member 806 is folded such that the front surface 814 of the secondary housing 804 faces in the same direction as the first surface 810, with the second surface 812 facing downwardly.

In an exemplary embodiment, the pivoting bracket member 806 may be hinged at the connection to the secondary housing 804, and/or at the corner of the “L” in the bracket member 806 to provide a higher degree of adjustability. In an exemplary embodiment, the main housing 802 may include a recess in which at least part of the bracket member 806 may be received in the table-top mode.

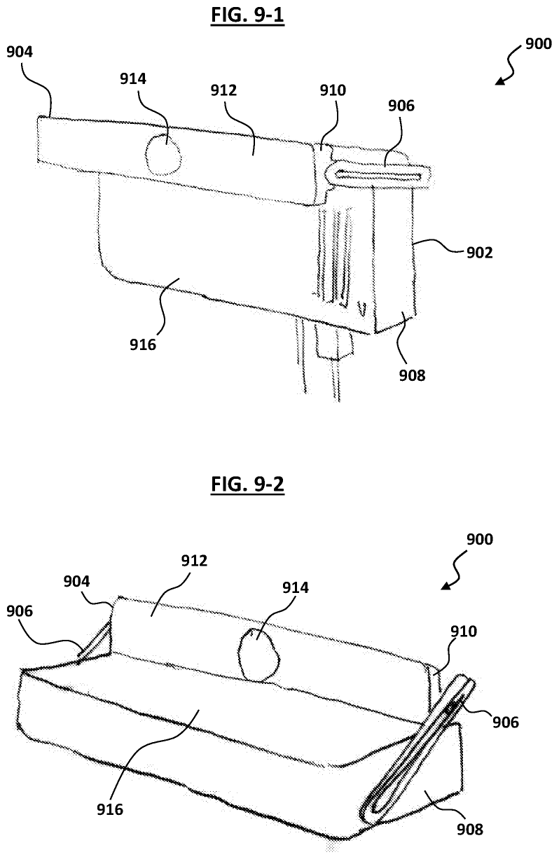

FIG. 9-1 and FIG. 9-2 illustrate another exemplary control unit 900. Referring to FIG. 9-1, the control unit 900 includes a main housing 902, and a secondary housing 904. The secondary housing 904 is connected to the main housing 902 by side arms 906, pivotally connected to main side surfaces 908 of the main housing 902 at first ends, and pivotally connected to secondary side surfaces 910 of the secondary housing 904 at second ends.

The side arms 906 allow the secondary housing 904 to be transitioned between a television mounted mode (as shown in FIG. 9-1), and a table-top mode (as shown in FIG. 9-2). In the television mounted mode, the side arms 906 are pivoted such that the secondary housing 904 (having a front surface 912 in which a camera aperture or lens 914 is centrally located) projects forward from a main surface 916 of the main housing 902. In the television mounted mode, control unit 900 may be mounted on the top of the television 102, with the secondary housing 904 extending over a front lip of the television 102, and the main surface 916 of the main housing 902 resting against the rear of the television 102.

In the table-top mode shown in FIG. 9-2, the side arms 906 are pivoted such that the secondary housing 904 rests on the main surface 916 (or opposing surface on the other side of the main housing 902), with the front surface 912 of the secondary housing 904 upright relative to the main surface 916.

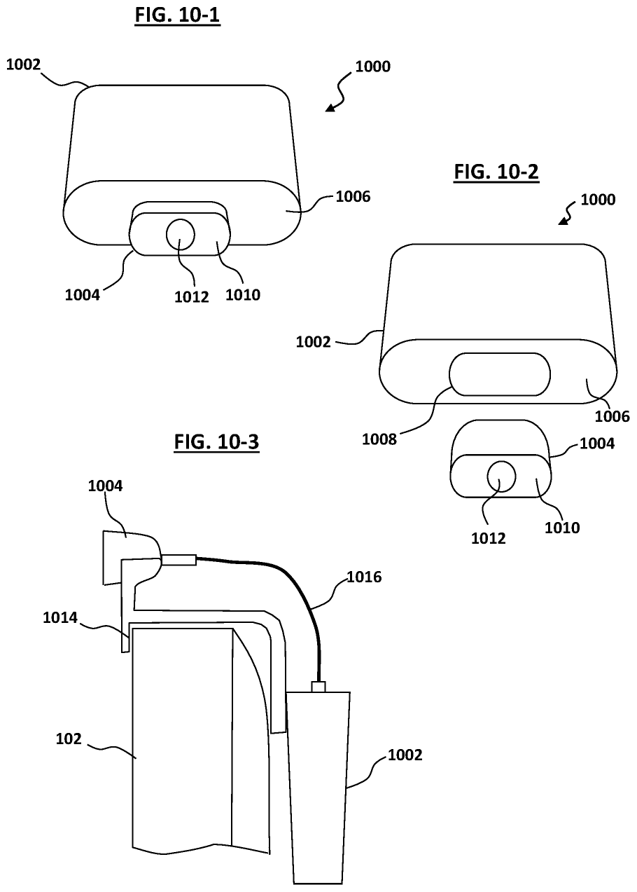

FIG. 10-1 and FIG. 10-2 illustrate another exemplary control unit 1000, including a main housing 1002 and a secondary housing 1004. The main housing 1002 has a front surface 1006 including a recess 1008 (not shown in FIG. 10-1, but see FIG. 10-2) in which the secondary housing 1004 may be removably located. In an exemplary embodiment, the recess 1008 may include a first connector configured to engage with a second connector on the rear of the secondary housing 1004 when the secondary housing 1004 is located in the recess 1008. In this exemplary embodiment, the secondary housing 1004 includes a forward surface 1010 in which a camera aperture or lens 1012 is centrally positioned.

FIG. 10-1 illustrates the control unit 1000 in a table-top mode, configured to be seated on a surface in use. FIG. 10-3 illustrates the control unit 1000 in a television mounted mode, in which a mounting bracket 1014 is secured over the top of the television. The secondary housing 1004 is removed from the main housing 1002 and positioned in the mounting bracket 1014 facing forward relative to the television 102. The main housing 1002 is secured to the mounting bracket 1014 behind the television 102, and connected to the secondary housing 1004 using a connector cable 1016.

No admission is made that any reference disclosed herein constitutes prior art. The discussion of the references states what their authors assert, and the applicants reserve the right to challenge the accuracy and pertinency of the cited documents. It will be clearly understood that, although a number of prior art publications are referred to herein, this reference does not constitute an admission that any of these documents form part of the common general knowledge in the field of endeavour, in New Zealand or in any other country.

Throughout this specification, the word “comprise” or “include”, or variations thereof such as “comprises”, “includes”, “comprising” or “including” will be understood to imply the inclusion of a stated element, integer or step, or group of elements integers or steps, but not the exclusion of any other element, integer or step, or group of elements, integers or steps.

Embodiments described herein may also be said broadly to consist in the parts, elements and features referred to or indicated in the specification of the application, individually or collectively, in any or all combinations of two or more of said parts, elements or features.

Where in the foregoing description reference has been made to integers or components having known equivalents thereof, those integers are herein incorporated as if individually set forth. It should be noted that various changes and modifications to the presently preferred embodiments described herein will be apparent to those skilled in the art. Such changes and modifications may be made without departing from the scope of the disclosure and without diminishing its attendant advantages. It is therefore intended that such changes and modifications be included within the present invention.

1. A communication system, including:
a television set;
a remote control which acts on the television set to control the television set;
a control unit coupled to the television set and to the internet;
the control unit configured to receive a signal from the internet and present at least a portion of the signal via the television set; and
wherein the control unit is remotely controlled by the remote control.

2. The system of claim 1 wherein the control unit is controlled by user operation of the remote control, wherein at least one normal function of the remote control is at least temporarily suspended by presentation of the at least a portion of the signal.

3. The system of claim 1, wherein the signal includes one or more of: a text message visually displayable on the television set, a video signal visually displayable on the television set, and an audio signal audibly presentable by the television set.

4. The system of claim 1, wherein the control unit includes a camera and a microphone, the control unit configured to transfer a signal including a video signal component and an audio signal component to a remote user device via the internet.

5. (canceled)

6. (canceled)

7. The system of claim 1, wherein the control unit is configured to activate the television set from a deactivated state on receiving the signal.

8. The system of claim 1, wherein the control unit is configured to control the television set to change to a communication system channel on receiving the signal.

9. The system of claim 7, wherein the control unit is configured to determine a current state of the television set on receiving the signal, and control the television set to return to the determined current state on conclusion of presentation of the at least a portion of the signal.

10. The system of claim 1, wherein the control unit includes an infrared transmitter, and is configured to control the television set by transmission of an infrared signal to the television set.

11. A method for using a television set with an associated remote control configured to control the television set for communication with a user of the television set, the method including the steps of:
connecting the television set to the internet through a control unit;
receiving a signal sent by a communicator via the internet to the control unit; and
controlling, using the control unit, the television set to present at least a portion of the signal via the television set,
wherein presentation of the signal is controlled, at least in part, by the user operating the remote control to remotely control the control unit.

12. The method of claim 11 wherein the received signal includes one or more of: a text message, a video signal, and an audio signal.

13. (canceled)

14. The method of claim 11, including the further step of at least temporarily suspending at least one normal function of the remote control during presentation of the at least a portion of the signal.

15. The method of claim 11, including gathering a video signal using a camera of the control unit, and an audio signal using a microphone of the control unit, and transferring a signal including the video signal and the audio signal component to a remote user device via the internet.

16. The method of claim 11, including activating the television set from a deactivated state using the control unit on receiving the signal.

17. The method of claim 11, including controlling the television set to change to a communication system channel using the control unit on receiving the signal.

18. The method of claim 16, including determining a current state of the television set on receiving the signal, and controlling the television set using the control unit to return to the determined current state on conclusion of presentation of the at least a portion of the signal.

19. The method of claim 16, wherein control of the television set is performed using an infrared signal transmitted by the control unit.

20. A control unit for a communication system, the control unit including:
an internet connection module, for connection to the internet;
a television connection module, for connection to a television set;
at least one processor configured to:
receive a communication signal sent from a first communicator via the internet;
present at least a portion of the communication signal via the television set;
receive control signals from a remote control of the television set.

21. The communication system of claim 1,
wherein the signal is from a communicator sent indicating a communication is to be presented to a user of the television set, and wherein the control unit is configured to:
determine whether a current state of the television set permits presentation of the communication, and
if required, control the television set to achieve a state capable of presenting the communication via the television set.

22. The method of claim 11, wherein the signal indicates a communication is to be presented to the user of the television set, and wherein the method further includes the steps of:
receiving a signal sent by the communicator via the internet to the control unit indicating a communication is to be presented to the user of the television set;
determining whether a current state of the television set permits presentation of the communication,
if required, controlling the television set using the control unit to achieve a state capable of presenting the communication via the television set.

23. The control unit of claim 20, wherein the communication signal indicates a communication from the first communicator is to be presented to a user of the television set, and wherein the at least one processor is further configured to:
determine whether a current state of the television set permits presentation of the communication, and
if required, control the television set to achieve a state capable of presenting the communication via the television set.
